(19) United States
(12) Patent Application Publication
(10) Pub. No.: US 2013/0051024 A1
(43) Pub. Date: Feb. 28, 2013

(54) Optical Transmitter Assembly, Optical Transceivers Including the Same, and Methods of Making and Using Such Optical Transmitter Assemblies and Optical Transceivers

(71) Applicant: Moshe AMIT, Los Angeles, CA (US)

(72) Inventor: Moshe AMIT, Los Angeles, CA (US)

(21) Appl. No.: 13/223,150

(22) Filed: Aug. 31, 2011

(51) Int. Cl. G02B 27/18; B23P 11/00

(52) U.S. Cl. 362/259; 29/428

(57) ABSTRACT

Methods for manufacturing and using an optical and/or optoelectronic device are disclosed. The optical or optoelectronic device and related methods may be useful for the transmitting of optical signals. The optical and/or optoelectronic device generally comprises (i) a laser diode on a mounting assembly, the laser diode providing an optical output signal, (ii) an optical communication medium configured to receive the optical output signal, (iii) a lens holder on the mounting assembly, (iv) and a lens in the lens holder, wherein the lens holder is in a position that aligns the lens with the laser diode and the optical communication medium.

### FIELD OF THE INVENTION

The present invention generally relates to optical signal transmission. More specifically, embodiments of the present invention pertain to methods and apparatuses for transmitting an optical signal using an optical and/or optoelectronic transmitter having a lens aligned with a laser diode.

### DISCUSSION OF THE BACKGROUND

FIG. 1 shows a conventional optical transmitter 100 comprising an optical signal generator 101, transmitter housing 120, lens mount 150, optical fiber connector 160, and fiber optic medium 165, including an optical fiber (not shown) and a sheath. As shown, optical signal generator 101 comprises a laser diode (LD) (e.g., a laser diode chip) 125, base 114, laser diode mount 110, and four pins, including a power supply pin 111, a ground pin 113, a data pin 112, and a complementary data pin (not shown, but generally behind the data pin 112). As shown, transmitter housing 120 seals or protects laser diode 125 and the electrical components in communication therewith, and provides a structure and/or surface on or in which lens mount 150 may be mounted or affixed. A focusing lens 155 is mounted on or in lens mount 150.

In conventional configurations, optical signal generator 101 receives electrical data signals (e.g., from data pin 112 and the complementary data pin), which are then processed by the electrical components in communication with LD chip 125. LD chip 125 then provides an optical output signal 115 to lens 155. Lens 155 is in the optical path from the LD chip 125 to the optical fiber in fiber optic medium 165, and lens 155 focuses optical output signal 115 to produce an optical signal 117 that is substantially aligned with the fiber optic medium 165. Fiber optic medium 165 is in communication with an optical or optoelectronic network (not shown).

Light (e.g., optical signal 117) enters fiber optic medium 165 within an acceptable range of angles (e.g., an acceptance angle or acceptance angle range). Light energy arriving outside the acceptance range of angles is not entirely transmitted (e.g., propagated) by fiber optic medium 165 to the optical or optoelectronic network. Thus, the angle and entry of optical signal 115 with respect to focusing lens 155 is of significant importance. That is, to maximize the bandwidth, intensity and/or power of the focused optical signal 117, the position of lens 155 with respect to optical output signal 115 typically requires very careful placement and alignment, generally by a process comprising a series of fine adjustments to the position of lens 155. However, it is possible that the lens 155 may be scratched, damaged, or inadvertently moved out of alignment during subsequent assembly and/or manufacturing processes.

The optical and optoelectronic networking industries seek optical transmitters in which a lens for a laser diode can be easily aligned and, once aligned and/or calibrated, can maximize optical transmission efficiency. Conventional optical transmitters, as discussed above, require careful placement and alignment of the lens with respect to the laser diode, and may expose the lens to unnecessary risks during further processing. This increases the amount of time required to align the lens with the laser diode. Misaligned lenses can reduce bandwidth, intensity and/or power of an output optical signal provided by the laser diode, and lenses that may be scratched, damaged, or moved out of alignment during subsequent processing may reduce the overall manufacturing yield.

This “Background” section is provided for background information only. The statements in this “Background” are not an admission that the subject matter disclosed in this “Background” section constitutes prior art to the present disclosure, and no part of this

“Background” section may be used as an admission that any part of this application, including this “Background” section, constitutes prior art to the present disclosure.

### SUMMARY OF THE INVENTION

The present invention is directed to an optical and/or optoelectronic transmitter having a lens and laser diode aligned and mounted on a mounting assembly, configured to provide an output optical signal; optical and/or optoelectronic transceivers including such a transmitter; and methods of making and using such optical and/or optoelectronic transmitters and transceivers.

Thus, embodiments of the present invention relate to an optical transmitter, methods for making the optical transmitter, and methods of transmitting an optical signal. The optical device generally comprises (i) a laser diode on a mounting assembly, the laser diode providing an optical output signal, (ii) an optical communication medium configured to receive the optical output signal, (iii) a lens holder on the mounting assembly, and (iv) a lens in the lens holder, wherein the lens holder is in a position that aligns the lens with the laser diode and the optical communication medium. In various embodiments, the optical device further comprises a photodetector on the mounting assembly, configured to monitor a power output of the laser diode. In some embodiments, the mounting assembly has an L shape. In further embodiments, the optical device comprises a housing or cap configured to house and/or protect the laser diode, the mounting assembly, the lens holder, and the lens.

The method of manufacturing the optical device generally comprises (i) affixing or securing a laser diode to a mounting assembly in the optical device, the laser diode providing an optical output signal, (ii) inserting an optical communication medium into or affixing an optical communication medium onto the optical device, the optical communication medium being configured to receive the optical output signal, (iii) affixing or securing a lens holder to the mounting assembly, (iv) affixing or securing a lens to the lens holder, (v) and adjusting a position of the lens holder such that the lens is aligned with the laser diode and the optical communication medium.

The method of transmitting an optical signal generally comprises (i) providing an electrical output signal to a laser diode, (ii) converting the electrical output signal to an optical output signal using the laser diode, and (iii) collimating or focusing the optical output signal with a lens, wherein the lens is affixed or secured to a lens holder (e.g., on a mounting assembly) and aligned between the laser diode and an optical communication medium. In some embodiments, the method of transmitting an optical signal comprises monitoring an output power of the laser diode using a photodiode.

Various embodiments and/or examples disclosed herein may be combined with other embodiments and/or examples, as long as such a combination is not explicitly disclosed herein as being unfavorable, undesirable or disadvantageous.

The present optical transmitter increases the coupling efficiency of laser diodes and focusing and/or collimating lenses. By (1) actively adjusting the position of the lens holder to align the lens with the laser diode, and (2) sealing a cap over the optical device, proper alignment of the lens and laser diode can be easily achieved, and the position of the lens is secured with respect to the laser diode. Additionally, after the relatively facile lens alignment, the lens can be fully protected, and further lens position adjustments or other alignment processes can be eliminated altogether, thereby minimizing the time required to align and calibrate the lens. Furthermore, the present invention advantageously provides an optical transmitter capable of providing a focused and/or collimated optical signal using a relatively small number of components (e.g., assemblies configured to adjust a position of a lens with respect to an optical transmitting device such as a laser diode) and/or a relatively small space.

These and other advantages of the present invention will become readily apparent from the detailed description of various embodiments below.

### BRIEF DESCRIPTION OF THE DRAWINGS

FIG. 1 is a diagram showing a conventional optical transmitter.

FIG. 2 is a diagram showing an exemplary optical and/or optoelectronic transmitter according to the present invention.

FIG. 3 is a diagram showing the exemplary optical and/or optoelectronic transmitter of FIG. 2 with a housing or cap thereon.

FIG. 4 is a diagram showing an exemplary optical and/or optoelectronic transceiver coupled to an optical communication medium.

FIG. 5 is a diagram showing an exemplary method of manufacturing an optical device according to the present invention.

FIG. 6 is a flow diagram showing an exemplary method of providing an optical signal according to the present invention.

FIG. 7 is a diagram showing an exemplary optical and/or optoelectronic triplex transceiver according to the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

For the sake of convenience and simplicity, the terms “optical” and “optoelectronic” are generally used interchangeably herein, and use of any one of these terms also includes the others, unless the context clearly indicates otherwise. Additionally, the terms “optical device,” “optoelectronic device,” “optical or optoelectronic device,” and “optical transmitter” are generally used interchangeably herein, and use of any one of these terms also includes the others, unless the context clearly indicates otherwise. Similarly, the terms “optical signal,” and “light” are generally used interchangeably herein, and use of any one of these terms also includes the others, unless the context clearly indicates otherwise. Also, for convenience and simplicity, the terms “connected to,” “coupled with,” and “coupled to” (which terms also refer to direct and/or indirect relationships between the connected, coupled and/or communicating elements unless the context of the term's use unambiguously indicates otherwise) may be used interchangeably, but these terms are also generally given their art-recognized meanings

The present invention concerns an optical and/or optoelectronic transmitter assembly, an optical and/or optoelectronic transmitter including the same, an optical and/or optoelectronic transceiver including the optical and/or optoelectronic transmitter, methods of making the optical and/or optoelectronic transmitter assembly, transmitter, and/or transceiver, and methods of transmitting an optical signal using the same. The present invention enjoys particular advantages in optical and/or optoelectronic transmitters and transceivers. The present method can be used to align optical signal generators (e.g., laser diodes) and lenses with greater ease and in a minimal time period, so that the coupling efficiency of the optical signal generators and lenses can be maximized. Additionally, using a cap to house the aligned laser diode and lens secures the position of the lens with respect to the laser diode. That is, after the lens is aligned (by adjusting the position of the lens holder and fixing the position of the lens holder once the lens is aligned), the lens can be fully protected, and further lens position adjustments or other alignment processes can be eliminated altogether. Thus, the present method and optical and/or optoelectronic transmitter easily aligns an optical signal generator with a lens. Additionally, the present optical and/or optoelectronic transmitter housing (e.g., cap) protects the lens (e.g., from foreign objects, debris, etc.).

The invention, in its various aspects, will be explained in greater detail below with regard to exemplary embodiments.

An Exemplary Optical and/or Optoelectronic Transmitter

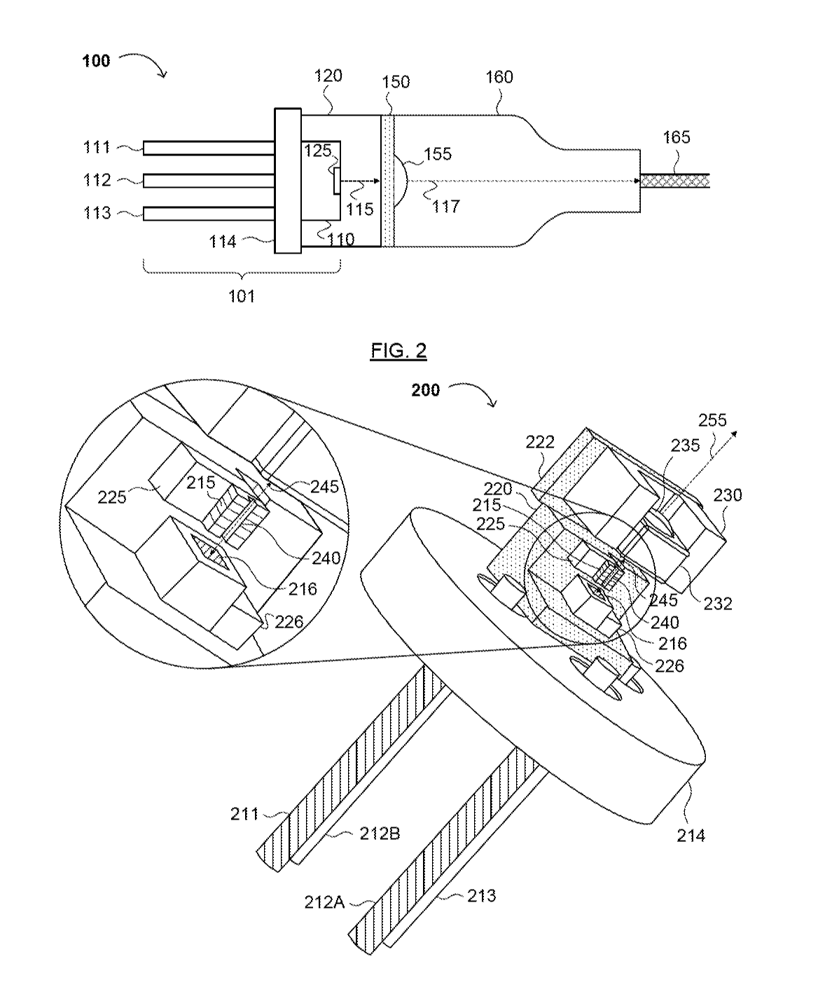

FIG. 2 shows an exemplary optical and/or optoelectronic transmitter 200 according to the present invention. As shown, optical and/or optoelectronic transmitter 200 comprises a laser diode (LD) 215, LD submount 225, a photodetector (e.g., a photodiode) 216, a photodetector submount 226, a mounting assembly 220, an optics mount 222, an optics holder or subassembly (e.g., lens holder) 230, and a lens 235. LD 215 has a facet 240 therein, which may function as a waveguide. As shown, optical and/or optoelectronic transmitter 200 also comprises a base 214 and four pins, including a power supply pin 211, a ground pin 213, and complementary data pins 212A and 212B. However, optical and/or optoelectronic transmitter 200 may comprise more than four pins. For example, optical and/or optoelectronic transmitter 200 may have additional pins (not shown) configured to provide a feedback signal (e.g., conveying the output power of the LD 215) from the photodetector 216 to a controller (not shown) elsewhere in the transmitter (or in a transceiver comprising the transmitter), and/or to receive instructions from the controller.

Optical and/or optoelectronic transmitter 200 is configured to receive electrical signals (e.g., receive the electrical signals at complementary data pins 212A and 212B) from an external network component (not shown) and provide an optical signal 245 from LD 215.

Electrical circuitry (not shown) provides the electrical signals to LD 215 (e.g., by converting and/or modulating the received electrical signals) in a form that LD 215 can output as an optical signal. Facet 240 directs or otherwise concentrates the energy from LD 215 along the direction of optical signal 245, through lens 235. Lens 235, mounted on or affixed to lens holder 230 (e.g., by active alignment), receives the optical signal 245 and provides a collimated and/or focused optical signal 255. In various embodiments, lens 235 is a collimating and/or focusing lens. Additionally, lens 235 comprises a central lens surrounded by a mechanical support portion 232. The mechanical support portion 232 can comprise or consist of the same material as lens 235, or any other material capable of being securely mounted on or affixed to lens holder 230.

Photodetector 216, mounted on photodetector submount 226 and adjacent to LD 215, is configured to monitor an output power of the optical signal 245 from LD 215. For example, photodetector 216 can be configured to provide a feedback signal (e.g., a voltage or current) to electrical circuitry (not shown). In one embodiment, the feedback signal is proportional to the optical power of optical signal 245. The feedback signal can be processed by the electrical circuitry (or other circuitry in the transmitter 200, such as a controller) so that LD 215 increases or decreases an output power or intensity of optical signal 245. For example, the feedback signal may result in one or more instructions from a microcontroller or microprocessor to adjust the output power or intensity of optical signal 245. The instructions, for example, may be received from an additional pin, as discussed above.

As shown, photodetector submount 226 comprises two portions. For example, photodetector submount 226 may comprise a relatively thick portion on which photodiode 216 is mounted, and a relatively thin portion adjacent to the relatively thick portion that provides structural support and/or electrical communication capability (e.g., through one or more traces, wire bonds, terminals, etc.) for circuitry such as an IC, packaged chip, and/or discrete devices. However, photodetector submount 226 may alternatively comprise a single L-shaped or flat submount.

As shown, LD 215 is mounted on or affixed or secured to laser diode submount 225. For example, LD 215 can be mounted on or affixed or secured to LD submount 225 using a binding substance (e.g., an adhesive or glue), which in some embodiments cures when exposed to a sufficient dose or amount of ultraviolet light and/or thermal energy (e.g., heat). For example, the binding substance may comprise an epoxy, an acrylate (e.g., a cyanoacrylate, acrylic acid, methacrylic acid, esters or amides of such acids, substituted variants of such [meth]acrylic acids, esters, or amides, etc.), a parylene, a silicone precursor, a polyurethane, or other adhesive known in the art that can be cured or solidified upon exposure to ultraviolet light and/or thermal energy (e.g., heat). Similarly, lens holder 230 is mounted on or affixed to optics mount 222 by the same or a similar binding substance. LD submount 225, photodetector submount 226, and optics mount 222 are also mounted on or affixed to mounting assembly 220 by the same or a similar binding substance. In some embodiments, optics mount 222 and mounting assembly 220 are a single structure. Furthermore, mounting assembly 220 is mounted on or affixed to base 214. Mounting assembly 220 can also be mounted on or affixed to base 214 by the same or a similar binding substance. In some embodiments, mounting assembly 220 has an L shape, with two orthogonal portions (e.g., a “horizontal” portion secured to the base 214 and a “vertical” portion on which the photodetector 216 is mounted or affixed).

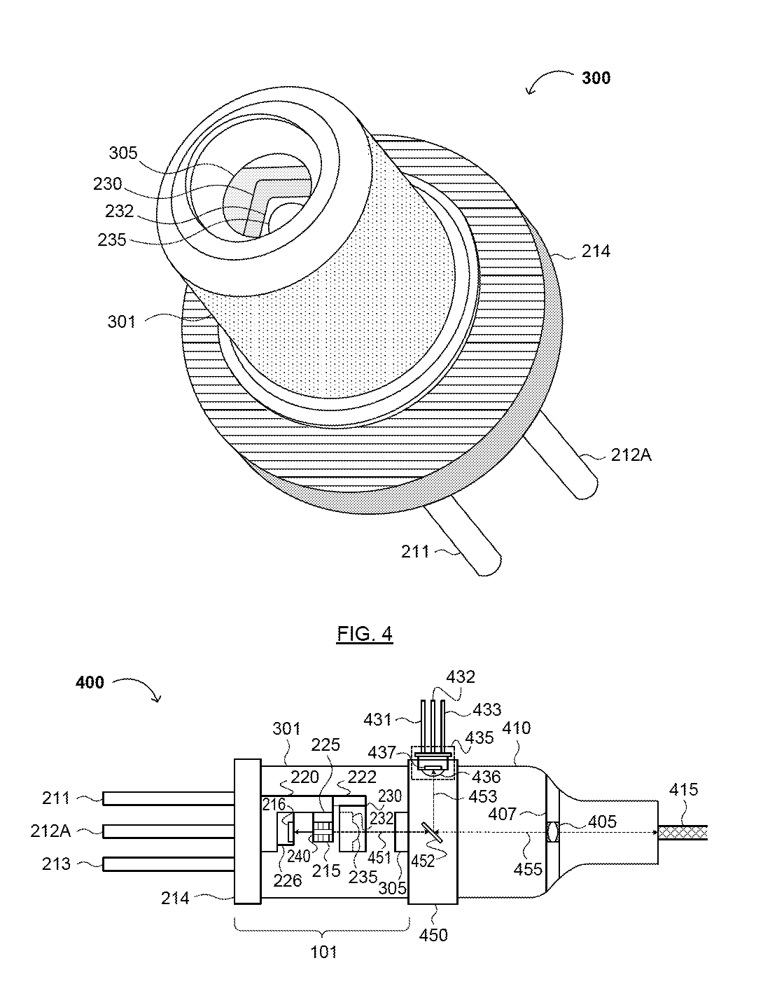

Furthermore, the position of lens holder 230 (and, in turn, lens 235) can be actively aligned with respect to LD 215. For example, a binding substance (e.g., similar to or the same as that used to mount LD 215 on LD submount 225) can be applied to the lens holder 230. The binding substance can be applied to the surface closest to optics mount 222, and can be applied using a nozzle, a pump, a syringe, a needle, a sprayer, or a hand-held device (not shown). Lens 235 is previously glued or permanently fixed in place with respect to lens holder 230. Lens holder 230 is then mounted on or affixed or secured to optics mount 222 by active alignment. The position of lens holder 230 can be mechanically or manually adjusted to align the lens 235 between LD 215 and a fiber optic medium (e.g., fiber optic medium 415 in FIG. 4). Alignment of the LD 215 with the fiber optic medium maximizes the bandwidth, intensity and/or power of the focused and/or collimated optical signal 255 (e.g., to be transmitted on the optical and/or optoelectronic network).

Adjustment of the position of lens 235 with respect to LD 215 can be accomplished by moving lens holder 230 in small increments (e.g., horizontally and/or vertically) until an output parameter (e.g., an output current, an output voltage, an output power, etc.) of optical signal 255 received by an optical communication medium (e.g., fiber optic medium 415 in FIG. 4) is maximized. The maximum output parameter value (e.g., a maximum output power) can be detected using a photodetector at the receiving end of the optical communication medium. The light received at the photodetector can be converted to an electrical current or signal, and a maximum output parameter value of the electrical current or signal from the photodetector can be determined. For example, the maximum output current (or other parameter) may be detected by incrementally moving the lens holder 230 in one direction (e.g., horizontally or vertically) until the output current or power starts to decrease, then moving the lens holder 230 back to the maximum position and repeating the incremental movements in the other direction (e.g., vertically or horizontally) until the output current or power starts to decrease, and iterating the process until the output current or power cannot be further increased. When the maximum output parameter value is detected or determined, the lens holder 230 is permanently adhered to optics mount 222 at the position where the maximum output parameter value is obtained. For example, lens holder 230 can be permanently adhered to optics mount 222 by irradiating the binding substance previously applied to lens holder 230, or by heating the transmitter 200 (e.g., in an oven or furnace).

Movement or adjustment of the lens holder 230 can be accomplished, for example, either manually (e.g., using tweezers or small forceps) or using a positioning or other holding device (not shown). The positioning device can comprise a holding, securing, or fastening device such as a clamp configured to hold the position of lens holder 230 in place with respect to optics mount 222, operably connected to positioning knobs, dials, levers or other mechanisms configured to adjust the position of the object held by the clamp. In general, one or more alignment knobs (e.g., for a screw-type alignment and/or positioning mechanism) on the positioning device may be used to adjust the position of lens holder 230. Each of the alignment knobs can be adjusted in minute increments by clockwise or counterclockwise rotation. Rotation of the alignment knobs subsequently alters a horizontal and/or vertical position (and, in some embodiments, a height) of lens holder 230 with respect to optics mount 222. In other words, the x-, y- and z-directions of the lens holder can be adjusted with respect to the optics mount 222.

During the movement or adjustment of lens holder 230, an output parameter of lens 235 (e.g., an output current, an output voltage, an output power, etc.) can be measured and/or monitored. After the maximum value of the output parameter (e.g., maximum output current) is determined, and while the parameter value is at the maximum value, a curing process (e.g., application of ultraviolet light and/or thermal energy) or heating (e.g., heating transmitter 200) is performed to solidify the binding substance and permanently adhere lens holder 230 to optics mount 222. In one embodiment, the equipment for performing active alignment of the lens 235 using the lens holder 230 can be automated.

In alternative embodiments, where lens holder 230 is permanently mounted on optics mount 222 prior to alignment of the lens and photodiode, optics mount 222 may be actively aligned with respect to LD 215. In such embodiments, aligning a position of optics mount 222 with respect to LD 215 aligns a position of lens 235 with respect to LD 215. When the maximum output power is received by the optical communication medium (or the maximum output current is output by a photodetector receiving the light from the optical communication medium), optics mount 222 is permanently secured to mounting assembly 220 by a process similar to that described above. Thus, lens holder 230 may have a different shape than the U-shape or C-shape shown in FIG. 2 (e.g., it can have a solid rectangular shape, entirely between the lens 235 and the optics mount 222; an L-shape, between the lens 235 and the optics mount 222 and on one side of the mechanical support portion 232; or an open square or rectangular shape, completely surrounding the lens 235 and mechanical support portion 232).

FIG. 3 shows an exemplary optical and/or optoelectronic transmitter 300 having a housing/cap 301 thereon. Optical and/or optoelectronic transmitter 300 comprises the same structures as or similar structures to those of optical and/or optoelectronic transmitter 200 of FIG. 2, and those structures having the same identification numbers discussed below with respect to FIG. 3 may be the same or substantially the same as those discussed above with respect to FIG. 2.

Specifically, housing/cap 301 is configured to house mounting assembly 220, lens holder 230, lens 235, mechanical support portion 232, optics mount 222, LD 215, LD submount 225, photodetector 216, and photodetector submount 226. Housing/cap 301 can be hermetically sealed to a surface (e.g., of base 214) of the optical and/or optoelectronic transmitter 300 such that a position of the components between the surface of base 214 and housing cap 301 are permanent. Pins (e.g., pins 211 and 212A) extend from an opposite surface of base 214.

Additionally, housing/cap 301 has a transparent window 305 that may comprise glass, a transparent plastic (e.g., a polycarbonate), a laminated combination thereof, etc. Window 305 allows the focused and/or collimated light (e.g., optical signal 255) from lens 235 to pass through (e.g., to an optical communication medium [not shown]), as discussed below in further detail with respect to FIG. 4.

An Exemplary Optical and/or Optoelectronic Transceiver

FIG. 4 shows an optical and/or optoelectronic transceiver 400, including a receiver 435, an optical communication medium (e.g., a fiber optic medium or optical fiber) 415, an optical communication medium connection housing 410, an optical cavity housing 450 (e.g., which encompasses a light processing cavity), and the exemplary optical and/or optoelectronic transmitter 300 of FIG. 3. As shown, receiver 435 comprises four pins, including a power supply pin 431, a ground pin 433, a data pin 432, and a complementary data pin (not shown, but generally behind the data pin 432). Receiver 435 also comprises lens 436, photodetector (e.g., a photodiode) 437, and circuitry (not shown) adapted to convert the received optical signal 453 to an electrical signal (e.g., to be transferred to another component in the network by data pin 432 and its complement [not shown]). Optical and/or optoelectronic transmitter 300 comprises the same structures as (or structures similar to) those of optical and/or optoelectronic transmitters 200 and 300 of FIGS. 2 and 3, where structures in optical and/or optoelectronic transmitter 300 having the same identification numbers discussed below with respect to FIG. 4 may be the same or substantially the same as those discussed above with respect to FIGS. 2 and 3.

Specifically, optical and/or optoelectronic transmitter 300 comprises mounting assembly 220, lens holder 230, lens 235, mechanical support portion 232, optics mount 222, LD 215, LD submount 225, photodetector 216, and photodetector submount 226. As discussed above, LD 215 has a facet 240 therein. Additionally, optical and/or optoelectronic transmitter 300 comprises base 214, cap 301 having a window 305, and four pins, including a power supply pin 211, a ground pin 213, a data pin 212A, and a complementary data pin (not shown, but generally behind the data pin 212A).

Optical and/or optoelectronic transmitter 300 is configured to receive an input signal (e.g., from the data pin 212A and the complementary data pin) from an external network component (not shown), and provide an optical signal 451. Optical signal 451 passes through beam splitter or filter 452 to optical fiber 415, and in the process, may become part of a bidirectional signal 455. Beam splitter 452 can be a dichroic mirror (e.g., a long wave pass [LWP] dichroic mirror, short wave pass [SWP] dichroic mirror, etc.), a wavelength selective filter (made of or coated with a reflective material), a polarization component, an amplitude modulation mask, a phase modulation mask, a hologram, and/or a grating. Additionally, optical and/or optoelectronic transceiver 400 receives an optical signal 453 at receiver 435 from beam splitter 452 in optical cavity housing 450.

In some embodiments, optical communication medium connection housing 410 comprises a lens 405, configured to (i) focus and/or collimate optical signal 451 before it is provided to optical communication medium 415, and/or (ii) focus and/or collimate the received portion of optical signal 455 before it is reflected by beam splitter/filter 452. Additionally, optical communication medium 415 is communicatively coupled to another optical receiver or transceiver in the optical and/or optoelectronic network (not shown), to which optical signal 451 is provided.

Thus, the present optical and/or optoelectronic transceiver 400 fully protects and secures a position of the lens in optical and/or optoelectronic transmitter 300. Furthermore, the optical and/or optoelectronic transceiver 400 of FIG. 4 is capable of providing a focused and/or collimated optical signal using a relatively small number of components (e.g., assemblies configured to adjust a position of a lens with respect to an optical transmitting device such as a laser diode) and/or a relatively small space.

An Exemplary Method of Manufacturing an Optical Device

As shown in FIG. 5, flowchart 500 illustrates an exemplary method of manufacturing an optical device according to the present invention. At 505, the method begins, and at 510, a laser diode is affixed or secured to a mounting assembly in the optical device. For example, affixing or securing the laser diode to the mounting assembly may comprise applying a binding substance (e.g., a glue or adhesive similar to or the same as that described herein) to the laser diode such that the laser diode is mounted on a laser diode submount, and mounting the laser diode submount to the mounting assembly (e.g., by using a similar adhesive). In some embodiments, the method further comprises affixing or securing a photodetector to the mounting assembly. The photodetector can be configured to monitor an output power (e.g., optical output signal) of the laser diode. In further embodiments, the photodetector is used to generate an electrical feedback signal, where the electrical feedback signal is provided to control circuitry (e.g., a microprocessor or microcontroller) in communication with the laser diode, to increase or decrease an output power of the optical output signal. Thus, the present method of manufacturing an optical device may further comprise attaching or affixing one or more electrical circuits (e.g., on a [printed] circuit board, or “PCB”) to the mounting assembly and/or base of the transmitter, and wiring the laser diode, the pins, and, when present, the photodiode to the electrical circuitry.

At 520, an optical communication medium is inserted into or affixed onto the optical device. The optical communication medium (e.g., optical communication medium 415 in FIG. 4) can be housed or enclosed in an optical communication medium connection housing (e.g., optical communication medium connection housing 410 in FIG. 4), and configured to receive an optical output signal from the laser diode.

At 530, a lens for collimating and/or focusing an optical signal from the laser diode is secured or affixed in a lens holder. The lens (e.g., lens 235 in FIG. 2) can be affixed or secured to the lens holder (e.g., lens holder 230 in FIG. 2) by applying a binding substance (e.g., a glue or adhesive as described herein) to one or more surfaces of the lens that interfaces with the lens holder, and placing the lens in the lens holder. At 540, an adhesive is applied to the lens holder. The adhesive can be a binding substance similar to or the same as those discussed herein. The binding substance can be applied to the lens holder surface opposite the cavity, receptacle, or socket in which the lens is held or placed, using a nozzle, a pump, a syringe, a needle, a sprayer, or a hand-held device.

At 550, the lens holder is placed on the mounting assembly. The lens holder can be placed on the mounting assembly such that the binding substance on the lens holder contacts the mounting assembly. Additionally, the lens holder can be placed in a position adjacent to the laser diode such that the lens in the lens holder receives light that is output from the laser diode.

At 560, the position of the lens holder is adjusted to align the lens between the laser diode and the optical communication medium so that the optical signal output from the laser diode is focused on the core of the optical communication medium (e.g., optical fiber) or on a lens that further focuses the optical signal on the core. In other words, the lens (e.g., lens 235 in FIGS. 2-4) is actively aligned between the laser diode (e.g., LD 215) and the optical communication medium (e.g., optical fiber 415). For example, adjusting the position of the lens holder may comprise holding or securing a position of the lens holder with respect to the mounting assembly, and moving a position of the lens holder (e.g., in increments in a horizontal, vertical and/or orthogonal direction [e.g., x-, y- and/or z-direction]) with respect to the mounting assembly to align the lens with the laser diode and the optical communication medium. Aligning the lens with the laser diode and the optical communication medium may comprise measuring and/or monitoring an output parameter (e.g., an output current, an output voltage, an output power, etc.) of the laser diode and/or the focused and/or collimated optical signal to determine the maximum value of the output parameter (e.g., the maximum output power or current), and determining the lens holder position at which the output parameter has the maximum value.

At 570, the lens holder is permanently affixed or secured to the mounting assembly when the output parameter is at the maximum value (e.g., as determined at 560). Permanently affixing or securing the lens holder to the mounting assembly may comprise curing (e.g., applying ultraviolet light and/or thermal energy to the binding substance) or heating (e.g., heating the optical and/or optoelectronic transmitter 200 of FIG. 2) to solidify the binding substance (e.g., the glue or adhesive) and permanently adhere the lens holder to the mounting assembly. The curing process may be the same as or similar to that discussed above with respect to FIG. 2 (e.g., that used to mount or affix LD 215 to LD submount 225 in FIG. 2).

At 580, a cap is mounted on or affixed to the base of the transmitter in the optical device. For example, the cap can cover mounting assembly 220, lens holder 230, lens 235, mechanical support portion 232, optics mount 222, LD 215, LD submount 225, photodetector 216, and photodetector submount 226 (e.g., as discussed above with respect to cap 301 of FIG. 3), thereby securing the position of the lens with respect to the laser diode. Using the cap ensures that the position at which the output efficiency of the laser diode is maximized is permanent. At 585, the method ends.

An Exemplary Method of Transmitting an Optical Signal

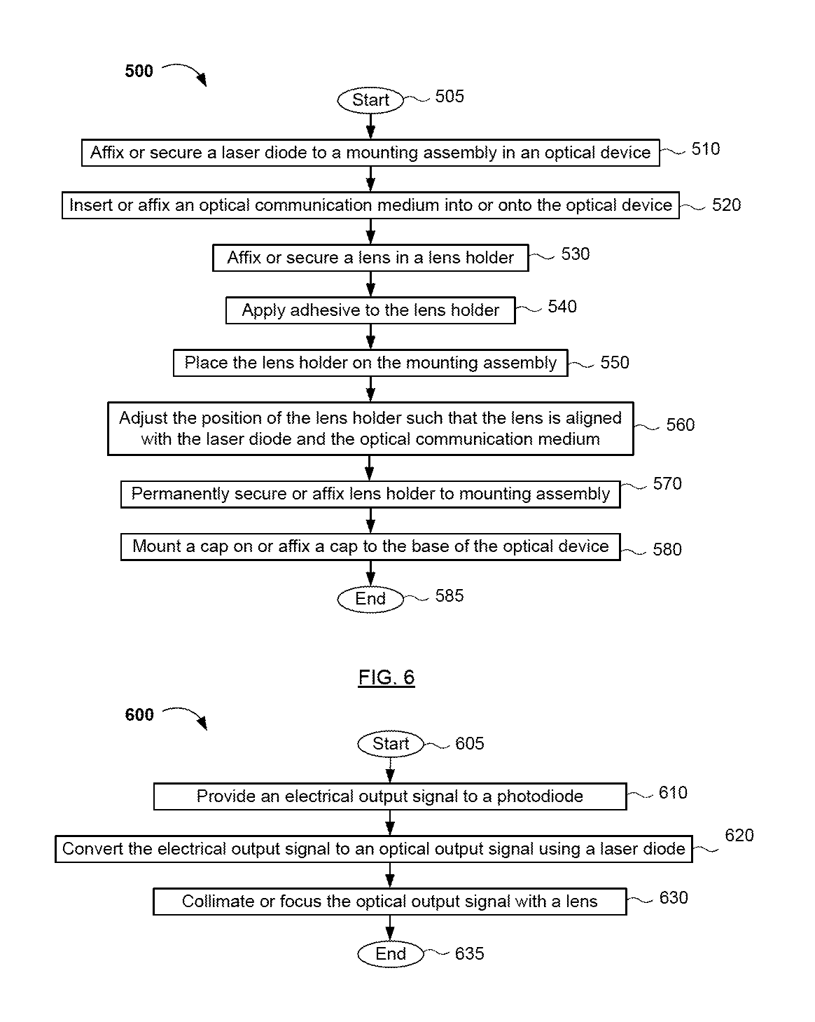

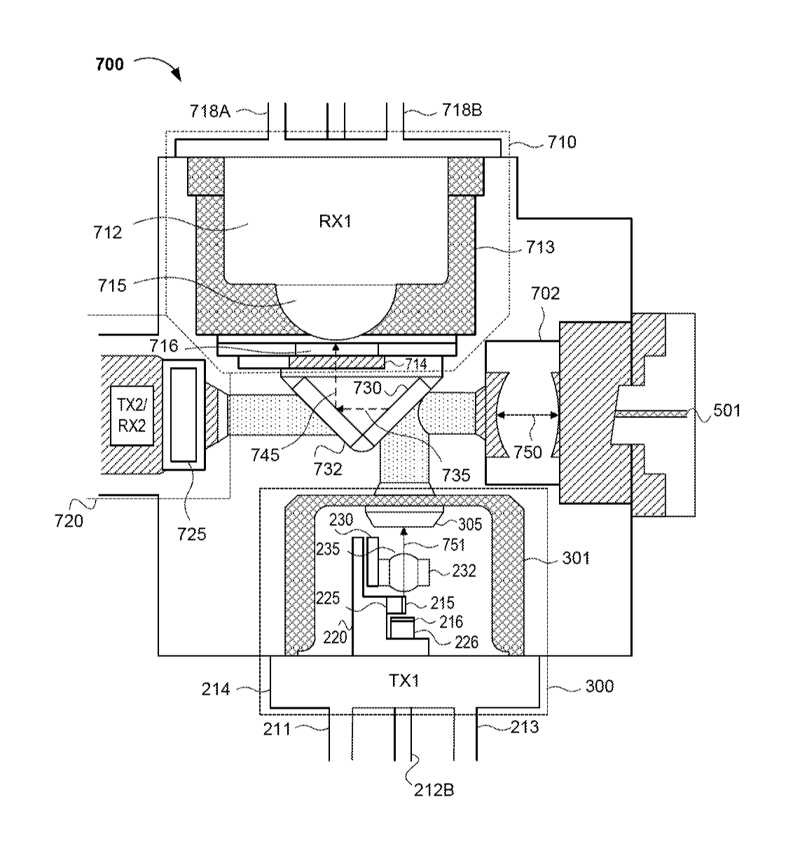

As shown in FIG. 6, flowchart 600 illustrates an exemplary method of transmitting an optical signal. As shown, at 605 the method begins, and at 610, an electrical output signal is provided to a laser diode. In one embodiment, providing the electrical output signal to the laser diode may comprise providing the electrical output signal from electrical circuitry (e.g., mounted on a PCB) to the laser diode (e.g., by converting and/or modulating the received electrical output signal) in a form that the laser diode can output as an optical signal. For example, providing the electrical output signal to the laser diode may comprise providing (i) a bias voltage or bias current and (ii) an electrical data signal to a modulator electrically coupled to the laser diode, where the bias voltage and/or current may be controlled by a microprocessor or microcontroller in electrical communication with the electrical circuitry, and the electrical data signal may come from one or more pins in electrical communication with the transmitter.

At 620, the received electrical output signal is converted to an optical output signal using the laser diode. In some embodiments, the method may further comprise detecting the power of the optical output signal using a photodetector configured to monitor a power output of the laser diode. The photodetector can also be used to generate an electrical feedback signal. In further embodiments, the feedback signal is provided to control circuitry (e.g., a microprocessor or microcontroller) in communication with the laser diode, to increase or decrease an output power of the optical output signal.

At 630, the optical output signal is collimated and/or focused with a lens. The lens is generally affixed or secured to a mounting assembly (on which the photodetector is also monitored) by a lens holder, and aligned between the laser diode and an optical communication medium. Collimating the optical output signal with the lens results in an optical output signal having parallel light waves directed towards the core or the lens focused on the core. Focusing the optical output signal results in the optical output signal being concentrated or focused on a certain spot or location (e.g., the end point or opening of the core of an optical fiber). At 635, the method ends.

An Exemplary Optical and/or Optoelectronic Triplex Transceiver

FIG. 7 illustrates an exemplary optical and/or optoelectronic triplex transceiver 700 according to the present invention. As shown, triplex transceiver 700 comprises receiver 710, transmitter or receiver 720, and exemplary optical and/or optoelectronic transmitter 300 (discussed above with respect to FIG. 3). Triplex transceiver 700 further comprises a lens 702, a first beam splitter 730, and a second beam splitter 732. As shown, optical and/or optoelectronic transmitter 300 comprises the same structures as (or structures similar to) those of optical and/or optoelectronic transmitters 200, 300, and 400 of FIGS. 2, 3, and 4, and those structures having the same identification numbers discussed below with respect to FIG. 7 may be the same or substantially the same as those discussed above with respect to FIGS. 2, 3, and 4. The invention also contemplates a transmitter-only device, including the first and second transmitters 300 and 720 (with the receiver 710 and beam-splitter 732 removed), optionally having a third transmitter (not shown) in place of the receiver 710 (and with beam-splitter 732 present). Duplex and triplex transceivers (e.g., transceiver 400 of FIG. 4 or transceiver 700 of FIG. 7) including one or more transmitters with the present actively-aligned lens, lens holder and photodiode are particularly advantageous in systems that transmit collimated light or optical signals, since the distances between light-processing components in the transceiver can be increased significantly.

Receiver 710 comprises receiver component(s) and circuitry 712 (e.g., a photodiode and one or more amplifiers), a bandpass filter 714, a lens 715 and a cap or housing 713 including a window 716. Receiver circuitry 712 can comprise a photodiode or any other device configured to convert an optical signal into an electrical signal (e.g., to be output on data pins 718A-B). Bandpass filter 714 is configured to filter (e.g., reduce the size of the wavelength band of) a received optical signal (e.g., optical signal 745).

Furthermore, receiver 710 comprises a lens 715 configured to focus the filtered, reflected optical signal 745. As shown, lens 715 is a half ball lens, which may comprise a curved surface facing second beam splitter 732 and a flat surface facing receiver circuitry 712. Alternatively, the lens may comprise a concave lens, a convex lens, and/or or a combination of concave or convex lenses. Lens 715 can be placed anywhere in the light path between second beam splitter 732 and receiver circuitry 712.

As discussed above with respect to FIG. 4, optical and/or optoelectronic transmitter 300 comprises mounting assembly 220, lens holder 230, lens 235, mechanical support portion 232, optics mount (not shown), LD 215, LD submount 225, photodetector 216, window 305, and photodetector submount 226. As shown, window 305 of optical and/or optoelectronic transmitter 300 allows the focused and/or collimated optical signal 751 from lens 235 to pass through to first beam splitter 730. First beam splitter 730 reflects the focused and/or collimated optical signal 751 towards lens 702. Lens 702 provides a collimated and/or focused optical signal 750 to fiber optic medium 501. Fiber optic medium 501 may be in communication with an optical or optoelectronic network (not shown).

As discussed above, triplex transceiver 700 comprises a first beam splitter 730, a second beam splitter 732, and a lens 702. In various embodiments, the first beam splitter 730 may comprise a dichroic mirror or other beam splitter (e.g., a long wave pass [LWP] dichroic mirror, short wave pass [SWP] dichroic mirror, etc.), a wavelength selective filter (comprising a material that selectively reflects one or more wavelengths or wavelength bands of light), a polarization component, an amplitude modulation mask, a phase modulation mask, a hologram, and/or a grating. Additionally, as shown in FIG. 7, first beam splitter 730 is positioned at a 45° angle (i.e., the angle of incidence) with respect to a received optical signal (e.g., optical signal 751). In alternative embodiments, the angle of incidence of the received optical signal on first beam splitter 730 is 45°±m°, where m=0.5 or any positive number less than 0.5. Second beam splitter 732 may be substantially similar to first beam splitter 730 (e.g., it may comprise a dichroic mirror or a wavelength selective filter that is selective for different wavelength[s] or wavelength band[s]). Lens 702 may be configured to provide a first focused and/or collimated optical signal (e.g., an input portion of optical signal 750) to beam splitter 730, and a second focused and/or collimated optical signal (e.g., an output portion of optical signal 750) to fiber optic medium 501.

In some embodiments, an optical signal (e.g., part of “bidirectional” optical signal 750) is received from fiber optic medium 501 (e.g., from an optical or optoelectronic network [not shown]) having a wavelength different from that of output optical signal 751. The part of optical signal 750 received from fiber optic medium 501 passes through lens 702, which focuses and/or collimates an input portion of optical signal 750, and first beam splitter 730 allows light having a wavelength different from that of output optical signal 751 to pass through to second beam splitter 732. Thus, optical signal 751 may have a first wavelength, and the input portion of optical signal 750 (received from fiber optic medium 501) may have a second wavelength different from the first wavelength. The first and second wavelengths may differ by a minimum of about 100-200 nm, generally up to about 500-1000 nm. Alternatively, the first and second wavelengths may differ by at least about 5, 10, 15 or 20%, up to as much as 25, 50 or 100%. Second beam splitter 732 provides a reflected light wave (e.g., optical signal 745) having the second wavelength to receiver 710.

As shown in FIG. 7, the triplex transceiver 700 comprises a second transmitter 720, configured to transmit a second output optical signal having a third wavelength (or wavelength band) different from the first and second wavelengths or wavelength bands through lens 725, first and second beam splitters 730 and 732, and lens 702 to optical communication medium 501. The second transmitter 720 may be the same as or different from transmitter 300. However, in an alternative embodiment, the triplex transceiver 700 comprises a second receiver 720 configured to receive a second input (received) portion of optical signal 751 (e.g., having the third wavelength). The second receiver 720 may comprise a photodiode and one or more amplifiers similar to receiver 710.

In general, when the triplex transceiver 700 comprises a second transmitter 720, the second transmitter 720 is first aligned with the fiber optic medium 501, generally by fixing the position of the components in the second transmitter 720, then adjusting the horizontal, vertical and/or depth positions (e.g., x-, y- and z-positions) of the fiber optic medium 501 until the maximum optical power is received by the fiber optic medium 501, after which the position of the fiber optic medium 501 is permanently fixed. In general, beam splitters 730 and 732 are in place prior to such alignment. Thereafter, either the receiver 710 (e.g., the lens and photodiode in the receiver 710) or the first transmitter 300 (e.g., the lens and laser diode in the transmitter 300) is aligned with the fiber optic medium 501, then the other of the receiver 710 or the first transmitter 300 is aligned with the fiber optic medium 501. The first transmitter 300 (more particularly, the lens and laser diode in the transmitter 300) is aligned with the fiber optic medium 501 by the active alignment process disclosed herein, and the receiver 710 (more particularly, the lens and photodiode in the receiver 710) is aligned with the fiber optic medium 501 by a conventional method.

By utilizing the exemplary optical and/or optoelectronic transceiver 700 of FIG. 7, where an optical and/or optoelectronic transmitter having a lens aligned with a laser diode is utilized, the optical and/or optoelectronic transceiver 700 can be efficiently coupled to an optical communication medium. Additionally, by securing the present lens and laser diode on a mounting assembly, the position of the lens is secure with respect to the laser diode, and further lens position adjustments can be eliminated.

### CONCLUSION/SUMMARY

Thus, the present invention provides an optical device, methods for making the optical device, and a method of processing an optical signal (for example, processing the optical signal using the device).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An optical or optoelectronic device comprising:
a laser diode on a mounting assembly, said laser diode providing an optical output signal;
an optical communication medium configured to receive said optical output signal;
a lens holder on said mounting assembly; and
a lens in said lens holder, wherein said lens holder is in a position that aligns said lens with said laser diode and said optical communication medium.

2. The optical device of claim 1, further comprising a housing or cap configured to house said laser diode, said mounting assembly, said lens holder, and said lens.

3. The device of claim 2, wherein said housing or cap comprises a glass window between said laser diode and said optical communication medium, said glass window configured to permit light from said laser diode to pass through to said optical communication medium.

4. The device of claim 1, wherein said lens comprises a collimating lens.

5. The device of claim 1, further comprising a photodetector on said mounting assembly configured to monitor a power output of said laser diode.

6. The device of claim 5, wherein said photodetector is configured to provide a feedback signal related to an optical power of said optical output signal.

7. The device of claim 5, wherein said mounting assembly has an L shape comprising a first portion and a second portion, wherein said laser diode and said photodetector are on said first portion of said mounting assembly, and said lens holder is on said second portion of said mounting assembly.

8. A method of manufacturing an optical device, comprising:
affixing or securing a laser diode to a mounting assembly in said optical device, said laser diode providing an optical output signal;
inserting an optical communication medium into or affixing an optical communication medium onto said optical device, said optical communication medium being configured to receive said optical output signal;
affixing or securing a lens holder to said mounting assembly;
affixing or securing a lens to said lens holder; and
adjusting a position of said lens holder such that said lens is aligned with said laser diode and said optical communication medium.

9. The method of claim 8, further comprising affixing or securing a housing or cap to said optical device, said housing or cap configured to house said laser diode, said mounting assembly, said lens holder, and said lens.

10. The method of claim 9, wherein affixing or securing said housing or cap to said optical device comprises hermetically sealing said housing or cap to the base of said laser diode.

11. The method of claim 8, further comprising affixing or securing a photodetector to said mounting assembly, said photodetector configured to monitor an output power of said laser diode.

12. The method of claim 11, wherein said mounting assembly has an L shape comprising a first portion and a second portion, and affixing or securing said laser diode and said lens holder to said mounting assembly comprises affixing or securing said laser diode and said lens holder to said first portion of said mounting assembly, and affixing or securing said photodetector to said mounting assembly comprises affixing or securing said photodetector to said second portion of said mounting assembly.

13. The method of claim 11, wherein adjusting said lens holder comprises (i) converting an output power of said optical output signal to an output current using said photodetector, (ii) determining a maximum output current of said photodetector, and (iii) permanently affixing or securing said lens holder to said mounting assembly when said maximum output current is output by said photodetector.

14. A method of transmitting an optical signal, comprising:
providing an electrical output signal to a laser diode;
converting said electrical output signal to an optical output signal using said laser diode; and
collimating or focusing said optical output signal with a lens secured in a lens holder, wherein said lens holder is affixed to a mounting assembly, and said lens is aligned between said laser diode and an optical communication medium.

15. The method of claim 14, further comprising monitoring an output power of said laser diode using a photodiode.

16. The method of claim 15, wherein said photodiode is configured to provide a feedback signal related to an optical power of said optical output signal.

17. The method of claim 15, wherein said laser diode and said photodiode are mounted on said mounting assembly.

18. The method of claim 17, wherein said mounting assembly has an L shape comprising a first portion and a second portion, said laser diode and said lens holder are mounted on said first portion of said mounting assembly, and said photodetector is mounted on said second portion of said mounting assembly.

19. The method of claim 14, wherein said lens is a collimating lens.

20. The method of claim 14, wherein said optical output signal is provided to said optical communication medium through a transparent window in a housing or cap secured over said laser diode, said lens, said lens holder and said mounting assembly.
